(19) United States
(12) Patent Application Publication
(10) Pub. No.: US 2006/0247925 A1
(43) Pub. Date: Nov. 2, 2006

(54) Virtual push-to-talk

(75) Inventors: Walter Haenel, Holzgerlingen (DE); Baiju D. Mandalia, Boca Raton, FL (US)

Correspondence Address: CUENOT & FORSYTHE, L.L.C., 12230 FOREST HILL BLVD., STE. 120, WELLINGTON, FL, 33414, US

(73) Assignee: INTERNATIONAL BUSINESS MACHINES CORPORATION, Armonk, NY (US)

(21) Appl. No.: 11/115,900

(22) Filed: Apr. 27, 2005

(51) Int. Cl. G10L 11/06

(52) U.S. Cl. 704/215

(57) ABSTRACT

A method of implementing a virtual push-to-talk function within a multimodal interface can include presenting a multimodal interface having a voice-enabled user interface element and locating a visual identifier proximate to the voice-enabled user interface element. The visual identifier can signify that the voice-enabled user interface element is configured to receive speech input. The method further can include activating a grammar associated with the voice-enabled user interface element responsive to a selection of the visual identifier and modifying an appearance of the visual identifier to indicate that the grammar associated with the voice-enabled user interface element is active.

### BACKGROUND

1. Field of the Invention

The present invention relates to multimodal applications and multimodal user interfaces.

2. Description of the Related Art

As computing devices become smaller and more pervasive, users have come to expect access to data without limitation as to time or place. Traditional visual interfaces, such as those provided by Hypertext Markup Language (HTML) pages, provide only limited means for user interaction. The available forms of user interaction with HTML pages, while suitable for some purposes, may be inconvenient for others, particularly with respect to personal digital assistants (PDAs) which typically have small view screens.

Multimodal applications have sought to overcome the limitations of purely visual or audio interfaces. Multimodal applications provide users with the ability to interact according to a method that more naturally applies to a given environment. The term “mode” denotes a mechanism for input to, or output from, the user interface. Such mechanisms generally can be classified as visual or audio-based. Accordingly, multimodal applications represent a convergence of different forms of content including, but not limited to, video, audio, text, and images and support various modes of user input such as speech, keyboard, keypad, mouse, stylus, or the like. Output modes can include synthesized speech, audio, plain text, motion video, and/or graphics.

Multimodal browsers are computer programs that can render or execute multimodal applications, or documents, written in an appropriate markup language. A multimodal browser, for example, can execute an application written in Extensible HTML (XHTML)+Extensible Voice Markup Language (VoiceXML), referred to as X+V language. Still, other multimodal and/or voice-enabled languages, such as Speech Application Language Tags (SALT), can be executed. By including a multimodal browser, or a component of a multimodal browser, within a computing device, whether a conventional computer or a PDA, the host device can run multimodal applications.

One feature that has been used with multimodal browsers is referred to as “push-to-talk” (PTT). PTT refers to a feature whereby the user activates a button or other mechanism when providing spoken input. The PTT button is a physical mechanism or actuator located on the computing device executing the multimodal browser. Actuation of the PTT button causes speech recognition to be performed on received audio. By signaling when speech is to be processed, the PTT function allows the multimodal browser to capture or record the entirety of the user's speech, while also reducing the likelihood that the multimodal application will inadvertently capture, or be confused by, background noise.

Despite the benefits afforded by conventional multimodal browsers, disadvantages do exist. One such disadvantage is that conventional multimodal browsers do not provide any indication as to which fields of a multimodal form are voice-enabled. The multimodal application, when rendered, may cause a data entry page or form to be displayed. The page can have a plurality of different data entry fields, some voice enabled and some not. Typically, a user first must place a cursor in a field to make the field the active field for receiving input. At that point, the user may be informed through a text or voice prompt that the selected field can receive user speech as input. Prior to actually selecting the field, however, the user cannot determine whether the field is intended to receive speech or text as input. This can confuse users and lead to wasted time, particularly in cases where the user tries to speak to a field that is only capable of receiving text.

Another disadvantage relates to the manner in which PTT is implemented in conventional multimodal applications and/or devices. Typically, a single, physical button is used to implement the PTT function. When the button is activated, speech recognition becomes active. The user, however, is not provided with any indication as to which field of a plurality of different fields of a given form is active and will be the recipient of the user's speech. Such is the case because the same PTT button is used to activate speech recognition for each of the fields in the form. If the user activates the PTT button without first selecting the desired or appropriate target field, user speech may be directed to the last field selected, or a default field. Accordingly, the user may inadvertently provide speech input to the wrong, or an unintended, field. This can make multimodal applications inconvenient and less than intuitive.

Yet another disadvantage relates to PTT implementations which rely upon detecting a period of silence to stop the speech recognition process. That is, the user activates the PTT button and speech is collected and recognized until a period of silence is detected. The user typically is not required to hold the PTT button while speaking. Accordingly, the user is not provided any indication as to whether the multimodal application is still collecting and/or speech recognizing spoken input. In some cases, silence may not be detectable due to high levels of background noise in the user's environment. In such instances, the speech recognition function may not terminate. The user, however, would be unaware of this condition.

Finally, the use of a physical PTT button violates a common design philosophy for visual user interfaces. This design philosophy dictates that all operations of a graphical user interface (GUI) should be accessible from the keyboard or a pointing device. This allows the user to input data entirely from a keyboard or a pointing device thereby streamlining data input. Conventional PTT functions, however, require the user to activate a physical button on the device, whether a dedicated button or a key on a keyboard. The user is unable to rely solely on the use of a pointing device to access all functions of the GUI. This forces the user to switch between using the PTT button and a pointing device to interact with the multimodal interface.

It would be beneficial to provide users with a more intuitive and informative means for indicating voice-enabled fields and for indicating when speech recognition is active with respect to multimodal applications and/or interfaces.

### SUMMARY OF THE INVENTION

The present invention provides methods and apparatus relating to a virtual push-to-talk (PTT) button and corresponding functionality. One embodiment of the present invention can include a method of implementing a virtual PTT function in a multimodal interface. The method can include presenting the multimodal interface having a voice-enabled user interface element and locating a visual identifier proximate to the voice-enabled user interface element. The visual identifier can signify that the voice-enabled user interface element is configured to receive speech input. The method further can include activating a grammar associated with the voice-enabled user interface element responsive to a selection of the visual identifier and modifying an appearance of the visual identifier to indicate that the grammar associated with the voice-enabled user interface element is active.

Another embodiment of the present invention can include a multimodal interface. The multimodal interface can include at least one data input mechanism configured to receive user input in a modality other than speech and a user interface element configured to receive speech input. A visual identifier can be associated with the user interface element. The user interface element and the visual identifier can be displayed within the multimodal interface such that the visual identifier is located proximate to the user interface element. The visual identifier indicates that the user interface element is configured to receive speech input.

Other embodiments of the present invention can include a machine readable storage being programmed to cause a machine to perform the various steps described herein.

### BRIEF DESCRIPTION OF THE DRAWINGS

There are shown in the drawings, embodiments which are presently preferred; it being understood, however, that the invention is not limited to the precise arrangements and instrumentalities shown.

FIG. 1 is a schematic diagram illustrating a multimodal interface in accordance with the inventive arrangements disclosed herein.

FIG. 2 is a schematic diagram illustrating further aspects of the multimodal interface of FIG. 1 in accordance with the inventive arrangements disclosed herein.

FIG. 3 is a flow chart illustrating a method of implementing a virtual push-to-talk function in accordance with the inventive arrangements disclosed herein.

### DETAILED DESCRIPTION OF THE INVENTION

The inventive arrangements disclosed herein provide methods and apparatus relating to user-computer interaction using a multimodal interface. In accordance with one embodiment of the present invention, visual identifiers can be provided within a multimodal interface to indicate to users those data entry fields (fields) within the multimodal interface that are voice-enabled. Each visual identifier further can serve as a virtual “push-to-talk” (PTT) button in that activation of an identifier can indicate that speech processing resources should be activated to process user speech. Activation of a visual identifier further can indicate that any received user speech is to be provided to the field that is associated with the activated visual identifier.

The present invention allows a user to access functionality of a multimodal interface without having to switch between using a hardware-based PTT button and providing pointer type inputs. That is, the user is able to select a virtual PTT button, i.e. the visual identifier, to activate speech processing for the multimodal interface. Moreover, the present invention enables speech processing to be activated on a per voice-enabled field basis. As noted, inclusion of the visual identifiers provides users with an intuitive means for determining which fields of a multimodal interface are voice-enabled.

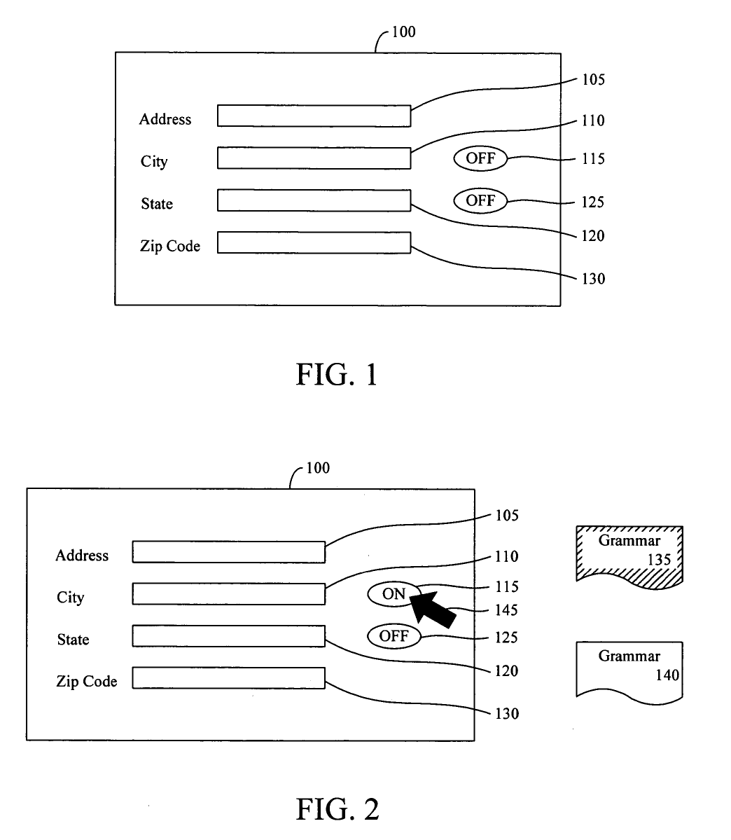

FIG. 1 is a schematic diagram illustrating a multimodal interface 100 in accordance with the inventive arrangements disclosed herein. According to one embodiment of the present invention, the multimodal interface 100 can be generated by a multimodal browser executing within an information processing system. The information processing system can be a computer system, a portable computing device, a server, or any other computing and/or communication device having suitable processing capabilities and audio circuitry for capturing user speech. More particularly, the multimodal browser can execute a multimodal application, or document, thereby generating the multimodal interface 100 which then can be displayed.

In one embodiment, the multimodal browser can be self-contained. In that case, the multimodal browser can include software-based resources for performing speech processing functions such as speech recognition, text-to-speech (TTS), audio playback, and the like. The speech processing resources can be local to the multimodal browser, i.e. within the same computing device. One example of such a browser is the multimodal browser being developed by International Business Machines (IBM) Corporation of Armonk, N.Y. and Opera Software ASA of Norway.

In another embodiment, the multimodal browser can be implemented in a distributed fashion where one or more components can be spread across multiple computer systems connected through a wired or wireless network. One common way of implementing a multimodal browser is to locate a visual browser within a client system and a voice browser, having or having access to speech processing resources, within one or more other remotely located computing systems or servers. The voice browser can execute voice-enabled markup language documents, such as Voice Extensible Markup Language (VoiceXML) documents, or portions of voice-enabled markup language code. Operation of the visual and voice browsers can be coordinated through the use of events, i.e. Extensible Markup Language (XML) events, passed between the two browsers. In such an embodiment, a client device executing the visual browser can be configured to capture audio and provide the audio to the voice browser along with other information captured through the multimodal interface displayed upon the client device. The audio can be temporarily recorded in the client device, optionally compressed, and then sent, or can be streamed to the remote voice browser.

As can be seen from the examples described herein, any of a variety of different browser configurations can be used with the present invention. The particular examples described herein, however, are not intended to limit the scope of the present invention as IBM Corporation provides a variety of software-based toolsets which can be used to voice-enable applications. One such toolset is the Multimodal Toolkit version 4.3.2 for Websphere® Studio 5.1.2.

Generally, a multimodal browser can load and execute a multimodal application. As noted, a multimodal application, or document, can be a multimodal markup language document written in Extensible Hypertext Markup Language (XHTML) and VoiceXML, hereafter referred to as X+V language. It should be appreciated, however, that multimodal applications can be written in other multimodal languages including, but not limited to, Speech Application Language Tags (SALT) or the like.

In any case, the multimodal interface 100 can be generated when the multimodal browser renders a multimodal application, or at least visual portions of the multimodal application, i.e. XHTML code segments. The multimodal interface 100 includes fields 105, 110, 120, and 130. Fields 110 and 120 are voice-enabled fields. That is, fields 110 and 120 are configured to receive speech input. As such, field 110 is associated with a visual identifier 115. Visual identifier 115 is located proximate to field 110. Similarly, field 120 is associated with visual identifier 125, which is located proximate to field 120.

Fields 105 and 130 are not voice-enabled. While shown as text boxes, it should be appreciated that fields 105 and 130 can be implemented as any of a variety of other graphical user interface (GUI) elements or components such as drop down menus, radio buttons, check boxes, or the like. The particular type of GUI element used to represent field 105 or 130 is not intended to limit the scope of the present invention, so long as fields 105 and 130 are not capable of receiving audio input, in this case user speech. Similarly, voice-enabled fields 110 and 120 can be implemented as other types of voice-enabled user interface elements, whether voice-enabled check boxes, radio buttons, drop down menus, or the like.

In one embodiment of the present invention, visual identifiers 115 and 125 can function as virtual PTT buttons. Rather than functioning on a global level with respect to the multimodal interface 100, i.e. one PTT button that is used for each voice-enabled field, each visual identifier can function only in conjunction with the field associated with that visual identifier. As shown in FIG. 1, visual identifiers 115 and 125 are in an inactive state as indicated by the appearance of each visual identifier. Accordingly, no user speech is being processed as an input to either field 110 or field 120 of the multimodal interface 100. With visual identifiers 115 and 125 being in an inactive state, so too are any speech recognition grammars that are associated with fields 110 and 120.

Depending upon the implementation of the host device operating system and the interface provided by the operating system to applications, visual identifiers also can be linked with the control of audio capture and routing. For example, it may be the case that detected audio is continually being provided from the operating system and that applications can choose to ignore or process the audio. Alternatively, it may be the case that a microphone of the device can be selectively enabled and disabled, or that audio can be selectively routed to an application. Each of these functions, or combinations thereof, can be linked to activation and/or deactivation of the visual identifiers if such functionality is provided by the operating system of the device displaying the multimodal interface 100.

FIG. 2 is a schematic diagram illustrating further aspects of the multimodal interface 100 of FIG. 1 in accordance with the inventive arrangements disclosed herein. FIG. 2 illustrates the case where visual identifier 115 has been selected and, therefore, is in an active state. The visual identifier can be selected (activated) and deselected (deactivated) in any of a variety of different ways. If, for example, a pointer 145 is used, a user can move the pointer 145 over the visual identifier 115 without performing a clicking action and subsequently deselect the visual identifier 115 by moving the pointer 145 off of the visual identifier 115.

In another embodiment, the user can click on the visual identifier 115 to activate it and then click on the visual identifier 115 a second time to deactivate it. It should be appreciated that a user also can use a keyboard to navigate, or “tab over”, to the visual identifier 115 and press the space bar, the enter key, or another key, to select the visual identifier 115 and repeat such a process to deselect the visual identifier 115.

It also should be appreciated that the visual identifier 115 can be deactivated automatically if so desired. In that case, the visual identifier 115 can be deactivated when a silence is detected that lasts for a predetermined period of time. That is, when the level of detected audio falls below a threshold value for at least a predetermined period of time, the visual identifier 115 can be deactivated.

The appearance of a visual identifier can be changed according to its state. That is, when a visual identifier is not selected, its appearance can indicate that state through any of a variety of different mechanisms including, but not limited to, color, shading, text on the identifier, or modification of the identifier shape. When the visual identifier is selected, its appearance can indicate such a state. As shown in FIG. 2, visual identifier 115 has been modified or altered with the text “ON” to indicate that it has been selected as opposed to indicating “OFF” in FIG. 1.

Each of the voice enabled fields 110 and 120 of multimodal interface 100 can be associated with a grammar that is specific to each field. In this case, field 110 is associated with grammar 135 and field 120 is associated with grammar 140. For example, as field 110 is intended to receive speech input specifying a city, grammar 135 can specify cities that will be understood by a speech recognition system. By the same token, since field 120 is intended to receive user speech specifying a state, grammar 140 can specify states that can be recognized by the speech recognition system.

When a visual identifier is selected, the grammar corresponding to the field to which the visual identifier is associated can be activated also. Thus, when visual identifier 115 is selected, grammar 135, being associated with field 110, is activated. The appearance of visual identifier 115 can be changed to indicate that grammar 135 is active. The appearance of visual identifier 115 can continue to indicate an active state so long as grammar 135 remains active.

If the multimodal browser that renders the multimodal interface is self-contained, i.e. includes speech processing functions, then the present invention can function substantially as described. In that case, the grammars likely are located within the same computing device as the multimodal browser.

If, however, the multimodal browser is distributed with a visual browser being resident on a client system and a voice browser being resident in a remotely located system, messages and/or events can be exchanged between the two component browsers to synchronize operation. For example, when a user selects visual identifier 115, the visual browser can notify the voice browser of the user selection. Accordingly, the voice browser can activate the appropriate grammar, in this case grammar 135, for performing speech recognition. When active, the voice browser can notify the visual browser that grammar 135 is active. Accordingly, the visual browser then can modify the appearance of visual identifier 115 to indicate the active state of grammar 135.

A similar process can be performed when grammar 135 is deactivated. If deactivation occurs automatically, then the voice browser can inform the visual browser of such an event so that the visual browser can change the appearance of visual identifier 115 to indicate the deactivated state of grammar 135. If deactivation is responsive to a user input deselecting visual identifier 115, then a message can be sent from the visual browser to the voice browser indicating the de-selection. The voice browser can deactivate grammar 135 responsive to the message and then notify the visual browser that grammar 135 has been deactivated. Upon notification, the visual browser can change the appearance of visual identifier 115 to indicate that grammar 135 is inactive.

Accordingly, a user can indicate when he or she will begin speaking by activating the visual identifier, in this case visual identifier 115. The multimodal application, having detected activation of visual identifier 115, automatically causes activation of grammar 135 and begins expecting user speech input for field 110. Accordingly, received user speech is recognized against the grammar 135. It should be appreciated that in one embodiment, selection of a field, i.e. placing a cursor in a voice-enabled field, can be independent of the PTT functions and activation of the visual identifiers disclosed herein. That is, unless the visual identifier for a field is selected, that field will not accept user speech input, whether selected by the user or not.

As can be seen from the illustrations described thus far, the present invention reduces the likelihood that speech inputs will go undetected by a system or be misrecognized. Further, by providing a virtual PTT button for each voice-enabled field, ambiguity as to which field is to receive speech input and which field is active is minimized. The appearance of the visual identifier provides the user with an indication as to whether the field proximate to, and associated with, the visual identifier is actively recognizing, or ready to process, received user speech.

In another aspect of the present invention, activation of a visual identifier also can be used to control the handling of audio within a system. As noted, activation and/or deactivation of a visual identifier can provide a mechanism through which a multimodal application selectively activates and deactivates a microphone. Further, audio can be selectively routed to the multimodal application, or interface, depending upon whether a visual identifier has been activated.

The above examples are not intended to limit the scope of the present invention. For example, the multimodal interface can be associated with one, two, three, or more grammars. The inventive arrangements disclosed herein also can be applied in cases where a one-to-one correspondence between voice-enabled fields and grammars does not exist. For example, two or more voice-enabled fields can be associated with a same grammar or more than one grammar can be associated with a given field. Regardless, activation of a visual identifier corresponding to a voice-enabled field can cause the grammar(s) associated with that field to be activated. Further, it should be appreciated that other visual identifiers also can be used within the multimodal interface to indicate the various states of the multimodal application and/or grammars.

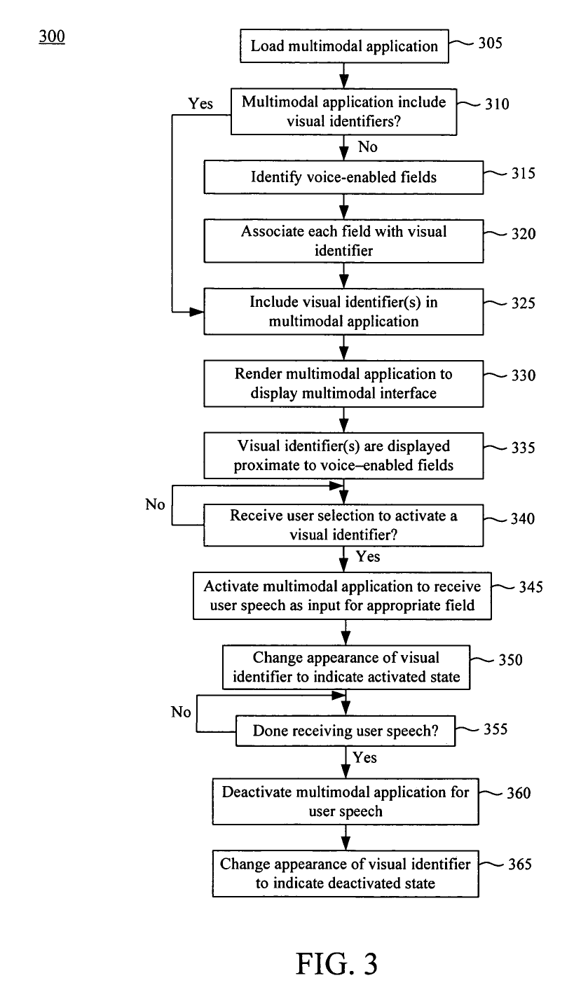

FIG. 3 is a flow chart illustrating a method 300 of implementing a virtual PTT function in accordance with the inventive arrangements disclosed herein. The method 300 can begin in a state where a multimodal application or document has been received or identified. The methods described herein can be performed whether the multimodal browser is a self-contained system or is distributed across one or more computer systems. In any case, in step 305, a multimodal application can be loaded into a multimodal browser.

In step 310, a determination can be made as to whether the multimodal application has been configured to include visual identifiers for the voice-enabled fields specified therein. If so, the method can proceed to step 330. If not, the method can continue to step 315. This allows the multimodal browser to dynamically analyze multimodal applications and automatically include visual identifiers within such applications if need be. Special tags, comments, or other markers can be used to identify whether the multimodal application includes visual identifiers.

Continuing with step 315, any voice-enabled fields specified by the multimodal application can be identified. When using X+V language, for example, a field can be voice-enabled by specifying an event handler which connects the field to an event such as the field obtaining focus. The connection between the XHTML form and the voice input field that is established by the event handler definition can be used by the multimodal browser to flag, or otherwise identify, input fields and/or controls as being voice-enabled.

In step 320, each voice-enabled field can be associated with a visual identifier that can be used to activate the multimodal application for receiving user speech for the associated field. In step 325, the visual identifier(s) can be included within the multimodal application. More particularly, additional code can be generated to include the visual identifier(s) or references to the visual identifier(s). If need be, a voice-enabled field being associated with a visual identifier can be modified, for example in cases where both the field and visual identifier will no longer fit within a defined space in a generated multimodal interface. Accordingly, existing code can be modified to ensure that the visual identifier is placed close enough to the field so as to be perceived as being associated with the field when viewed by a user.

In step 330, the multimodal application can be rendered thereby generating a multimodal interface which can be displayed. In step 335, each visual identifier is displayed proximate to the voice-enabled field to which that visual identifier was associated. As noted, each visual identifier can be displayed next to, or near, the field to which it is associated, whether before, after, above, or below, such that a user can determine that the visual identifier corresponds to the associated field. In step 340, a determination can be made as to whether a user selection to activate a visual identifier has been received. If not, the method can cycle through step 340 to continue monitoring for such an input. If a user selection of a visual identifier is received, the method can proceed to step 345. As noted, the visual identifier can be selected by moving a pointer over the visual identifier, clicking the visual identifier, or navigating to the visual identifier, for example using the tab key, and using a keyboard command to select it.

In step 345, the multimodal application can be activated to receive user speech as input. More particularly, the grammar that is associated with the selected visual identifier can be activated. This ensures that any received user speech will be recognized using the activated grammar. Without activating a grammar, any received user speech or sound can be ignored. As noted, however, activation and deactivation of visual identifiers also can be tied to enabling and/or disabling a microphone and/or selectively routing received audio to the multimodal application. Regardless, in step 350, the appearance of the visual identifier can be changed. The change in appearance indicates to a user that the multimodal application has been placed in an activated state. That is, a grammar associated with the selected visual identifier is active such that speech recognition can be performed upon received user speech using the activated grammar.

In step 355, a determination can be made as to whether the multimodal application has finished receiving user speech. In one embodiment, this can be an automatic process of detecting a silence lasting at least a predetermined minimum amount of time. In another embodiment, a user input can be received which indicates that no further user speech will follow. Such a user input can include the user removing a pointer from the visual identifier, clicking the visual identifier a second or subsequent time, a keyboard entry, or any other means of deselecting or deactivating the visual identifier.

If further user speech is to be received, the method can loop back to step 355 to continue monitoring. It should be appreciated that, during this time, any received speech can be processed and recognized, whether locally or remotely using the active grammar(s). If no further speech is to be received, the method can continue to step 360.

In step 360, the multimodal application can be deactivated for user speech. More particularly, the grammar that was active, now can be deactivated. Further, if so configured, the multimodal application can cause the microphone to be deactivated or effectively stop audio from being routed or provided to the multimodal application. In step 365, the appearance of the visual identifier can be changed to indicate the inactive state of the grammar. Step 365 can cause the visual identifier to revert back into its original state or appearance or otherwise change the appearance of the visual identifier to indicate that the grammar is inactive.

Method 300 has been provided for purposes of illustration. As such, it is not intended to limit the scope of the present invention as other embodiments and variations with respect to method 300 are contemplated by the present invention. Further, one or more of the steps described with reference to FIG. 3 can be performed in varying order without departing from the spirit or scope of the present invention.

The present invention provides a multimodal interface having one or more virtual PTT buttons. In accordance with the inventive arrangements, a virtual PTT button can be provided for each voice-enabled field of a multimodal interface. The virtual PTT buttons provide users with an indication as to which fields of a multimodal interface are voice-enabled and also increase the likelihood that received user speech will be processed correctly. That is, by including such functionality, users are more likely to begin speaking when the speech recognition resources are active, thereby ensuring that the beginning portion of a user spoken utterance is received. Similarly, users are more likely to stop speaking prior to deactivating speech recognition resources, thereby ensuring that the ending portion of a user spoken utterance is received.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program, software application, and/or other variants of these terms, in the present context, mean any expression, in any language, code, or notation, of a set of instructions intended to cause a system having an information processing capability to perform a particular function either directly or after either or both of the following: a) conversion to another language, code, or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A method of implementing a virtual push-to-talk function within a multimodal interface comprising:
presenting the multimodal interface having a voice-enabled user interface element;
locating a visual identifier proximate to the voice-enabled user interface element, wherein the visual identifier signifies that the voice-enabled user interface element is configured to receive speech input;
activating a grammar associated with the voice-enabled user interface element responsive to a selection of the visual identifier; and
modifying an appearance of the visual identifier to indicate that the grammar associated with the voice-enabled user interface element is active.

2. The method of claim 1, wherein the multimodal interface is associated with a plurality of grammars, the method further comprising selecting the grammar associated with the voice-enabled user interface element from the plurality of grammars responsive to the selection of the visual identifier.

3. The method of claim 1, further comprising:
detecting a period of silence; and
automatically deactivating the grammar associated with the voice-enabled user interface element responsive to said detecting step.

4. The method of claim 3, further comprising changing the appearance of the visual identifier to indicate that the grammar associated with the voice-enabled user interface element is not active.

5. The method of claim 1, further comprising deactivating the grammar associated with the voice-enabled user interface element responsive to a de-selection of the visual identifier.

6. The method of claim 5, further comprising changing the appearance of the visual identifier associated with the voice-enabled user interface element to indicate that the grammar is not active.

7. The method of claim 1, wherein the multimodal interface includes at least one graphical user interface element that is not voice-enabled, wherein the visual identifier associated with the voice-enabled user interface element distinguishes the voice-enabled user interface element from the at least one graphical user interface element that is not voice-enabled.

8. The method of claim 1, further comprising:
first dynamically identifying the voice-enabled user interface element within the multimodal interface; and
automatically associating the voice-enabled user interface element with the visual identifier.

9. The method of claim 8, further comprising automatically including the visual identifier, or a reference to the visual identifier, within a multimodal application that, when rendered, generates the multimodal interface.

10. A multimodal interface comprising:
at least one data input mechanism configured to receive user input in a modality other than speech;
a voice-enabled user interface element configured to receive speech input; and
a visual identifier associated with the voice-enabled user interface element, wherein the voice-enabled user interface element and the visual identifier are displayed within the multimodal interface and the visual identifier is located proximate to the voice-enabled user interface element, and wherein the visual identifier indicates that the voice-enabled user interface element is configured to receive speech input.

9. (canceled)

11. The multimodal interface of claim 10, wherein, responsive to activation of the visual identifier, speech recognition is activated for processing audio.

12. The multimodal interface of claim 11, wherein an appearance of the visual identifier is dynamically changed to indicate whether a grammar corresponding to the voice-enabled user interface element is active.

12. (canceled)

13. A machine readable storage, having stored thereon a computer program having a plurality of code sections executable by a machine for causing the machine to perform the steps of:
presenting a multimodal interface having a voice-enabled user interface element;
locating a visual identifier proximate to the voice-enabled user interface element, wherein the visual identifier signifies that the voice-enabled user interface element is configured to receive speech input;
activating a grammar associated with the voice-enabled user interface element responsive to a selection of the visual identifier; and
modifying an appearance of the visual identifier to indicate that the grammar associated with the voice-enabled user interface element is active.

14. The machine readable storage of claim 13, wherein the multimodal interface is associated with a plurality of grammars, the machine readable storage further causing the machine to perform the step of selecting the grammar associated with the voice-enabled user interface element from the plurality of grammars responsive to the selection of the visual identifier.

15. The machine readable storage of claim 13, further comprising:
detecting a period of silence; and
automatically deactivating the grammar associated with the voice-enabled user interface element responsive to said detecting step.

16. The machine readable storage of claim 15, further comprising changing the appearance of the visual identifier to indicate that the grammar associated with the voice-enabled user interface element is not active.

17. The machine readable storage of claim 13, further comprising deactivating the grammar associated with the voice-enabled user interface element responsive to a de-selection of the visual identifier.

18. The machine readable storage of claim 17, further comprising changing the appearance of the visual identifier associated with the voice-enabled user interface element to indicate that the grammar is not active.

19. The machine readable storage of claim 13, wherein the multimodal interface includes at least one graphical user interface element that is not voice-enabled, wherein the visual identifier associated with the voice-enabled user interface element distinguishes the voice-enabled user interface element from the at least one graphical user interface element that is not voice-enabled.

20. The machine readable storage of claim 13, further comprising:
first dynamically identifying the voice-enabled user interface element within the multimodal interface; and
associating the voice-enabled user interface element with the visual identifier.
